(19) United States
(12) Patent Application Publication
(10) Pub. No.: US 2009/0205310 A1
(43) Pub. Date: Aug. 20, 2009

(54) POWER GENERATION SYSTEM HAVING AN EXHAUST GAS ATTEMPERATING DEVICE AND SYSTEM FOR CONTROLLING A TEMPERATURE OF EXHAUST GASES

(75) Inventors: Joell Randolph Hibshman, II, Greer, SC (US); Gordon Raymond Smith, Ballston Spa, NY (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/034,263

(22) Filed: Feb. 20, 2008

(51) Int. Cl. F02C 6/04; F02C 7/14; F01K 11/02; F02C 9/00

(52) U.S. Cl. 60/39.182; 60/39.5; 60/664; 60/793

(57) ABSTRACT

An exhaust gas attemperating device is provided. The exhaust gas attemperating device includes a conduit in fluid communication with a gas turbine. The conduit is configured to receive exhaust gases from the gas turbine and has one or more apertures extending therethrough. The exhaust gas attemperating device further includes one or more atomizing nozzles extending through the apertures of the conduit. The atomizing nozzle is configured to inject a liquid through the aperture into the conduit, such that the liquid evaporates and decreases a temperature and an oxygen concentration of the exhaust gases in the conduit.

### BACKGROUND OF THE INVENTION

Power plants can include heat recovery steam generators (“HRSGs”) that can accumulate pockets of flammable gas from a gas turbine during the shutdown of the gas turbine. Purging the HRSG of such flammable gases is necessary to prevent auto-ignition of the flammable gases in the HRSG during a subsequent startup of the gas turbine when the HRSG can receive high temperature exhaust gases from the gas turbine. In one HRSG, a starter motor operates a gas turbine as a fan for ventilating the HRSG with ambient air to purge the flammable gases before the gas turbine begins combusting fuel to generate electricity. A drawback with this approach is that the purge process takes a relatively long time to complete, delaying the production of salable energy. The starter motor also consumes a significant amount of electrical power during the purge process.

Accordingly, the inventors herein have recognized a need for an exhaust gas attemperating device that can decrease a temperature and an oxygen concentration of exhaust gases being received by a HRSG system from a gas turbine. The attemperated exhaust gas stream may be used to effect simultaneous HRSG purging and gas turbine firing.

### BRIEF DESCRIPTION OF THE INVENTION

An exhaust gas attemperating device in accordance with an exemplary embodiment is provided. The exhaust gas attemperating device includes a conduit in fluid communication with a gas turbine. The conduit is configured to receive exhaust gases from the gas turbine. The conduit has at least one aperture extending therethrough. The exhaust gas attemperating device further includes at least one atomizing nozzle extending through the at least one aperture of the conduit and configured to inject a liquid through the at least one aperture into the conduit, such that the liquid evaporates and decreases a temperature and an oxygen concentration of the exhaust gases in the conduit.

A system for controlling a temperature and an oxygen concentration of exhaust gases produced by a gas turbine in accordance with another exemplary embodiment is provided. The system includes a fluid duct configured to route a liquid therethrough. The system further includes an isolation valve coupled to the fluid duct, the isolation valve configured to move between open and closed operational positions. The liquid is routed through the fluid duct when the isolation valve is moved to the open operational position. The isolation valve blocks the fluid duct when the isolation valve is moved to the closed operational position. The system further includes an actuator coupled to the isolation valve. The actuator is configured to move the isolation valve between the open and closed operational positions in response to first and second actuation signals, respectively. The system further includes an exhaust gas attemperating device including at least one atomizing nozzle and a conduit. The conduit is in fluid communication with the gas turbine. The conduit is configured to receive the exhaust gases from the gas turbine. The conduit has at least one aperture extending therethrough. At least one atomizing nozzle extends through at least one aperture of the conduit and is configured to inject the liquid through the at least one aperture into the conduit, such that the liquid evaporates in the conduit and decreases a temperature and an oxygen concentration of the exhaust gases in the conduit. The system further includes a speed sensor coupled to a compressor portion of the gas turbine. The speed sensor is configured to generate a speed signal indicative of a speed of the gas turbine. The system further includes a controller configured to receive the speed signal from the speed sensor and to determine a speed value based on the speed signal. The controller is further configured to generate the first actuation signal to induce the actuator to move the isolation valve to the open operational position when the controller determines that the speed value is greater than or equal to a threshold speed value.

A power generation system in accordance with another exemplary embodiment is provided. The power generation system includes a gas turbine configured to produce exhaust gases. The power generation system further includes an exhaust gas attemperating device including a conduit and at least one atomizing nozzle. The conduit is in fluid communication with the gas turbine. The conduit is configured to receive the exhaust gases from the gas turbine. The conduit has at least one aperture extending therethrough. The at least one atomizing nozzle extends through the at least one aperture of the conduit and configured to inject a liquid through the at least one aperture into the conduit, such that the liquid evaporates and decreases a temperature and an oxygen concentration of the exhaust gases in the conduit. The power generation system further includes a heat recovery steam generator in fluid communication with the conduit of the exhaust gas attemperating device. The heat recovery steam generator is configured to receive the exhaust gases from the conduit of the exhaust gas attemperating device. The power generation system further includes an exhaust stack in fluid communication with the heat recovery steam generator. The exhaust stack is configured to direct the exhaust gases from the heat recovery steam generator to the atmosphere.

An exhaust gas attemperating device in accordance with another exemplary embodiment is provided. The exhaust gas attemperating device includes a conduit configured to receive exhaust gases. The conduit has at least one aperture extending therethrough. The exhaust gas attemperating device further includes at least one atomizing nozzle extending through the at least one aperture of the conduit and configured to inject water through the at least one aperture into the conduit, such that the water evaporates and decreases a temperature and an oxygen concentration of the exhaust gases in the conduit.

A system for controlling a temperature and an oxygen concentration of exhaust gases in accordance with another exemplary embodiment is provided. The system includes a fluid duct configured to route water therethrough. The system further includes an isolation valve coupled to the fluid duct. The isolation valve is configured to move between open and closed operational positions. The water is routed through the fluid duct when the isolation valve is moved to the open operational position. The isolation valve blocks the fluid duct when the isolation valve is moved to the closed operational position. The system further includes an actuator coupled to the isolation valve. The actuator is configured to move the isolation valve between the open and closed operational positions in response to first and second actuation signals, respectively. The system further includes an exhaust gas attemperating device including at least one atomizing nozzle and a conduit. The conduit is configured to receive the exhaust gases. The conduit has at least one aperture extending therethrough. The at least one atomizing nozzle extends through the at least one aperture of the conduit and is configured to inject the water through the at least one aperture into the conduit, such that the water evaporates in the conduit and decreases a temperature and an oxygen concentration of the exhaust gases in the conduit. The system further includes a controller configured to generate the first and second actuation signals to induce the actuator to move the isolation valve between the open and closed operational positions, respectively.

### BRIEF DESCRIPTION OF THE DRAWINGS

FIG. 1 is a schematic of a power generation system having an exhaust gas attemperating device, in accordance with an exemplary embodiment;

FIGS. 2 and 3 are a flowchart of a method for controlling a temperature and an oxygen concentration of exhaust gases from a gas turbine, utilizing the exhaust gas attemperating device of FIG. 1 based on a speed of a compressor portion of the gas turbine, in accordance with an exemplary embodiment;

FIG. 4 is a schematic of a power generation system having an exhaust gas attemperating device, in accordance with another exemplary embodiment;

FIGS. 5 and 6 are a flowchart of a method for controlling a temperature and an oxygen concentration of exhaust gases from a gas turbine, utilizing the exhaust gas attemperating device of FIG. 4 based on a temperature of exhaust gases and a speed of a compressor portion of the gas turbine, in accordance with another exemplary embodiment; and

FIGS. 7 and 8 are a flowchart of a method for controlling a temperature and an oxygen concentration of exhaust gases from a gas turbine, utilizing the exhaust gas attemperating device of FIG. 4 based on a temperature of exhaust gases and a speed of a compressor portion of the gas turbine, in accordance with another exemplary embodiment.

### DETAILED DESCRIPTION OF THE INVENTION

Exemplary embodiments are directed to an exhaust gas attemperating device for controlling a temperature of exhaust gases being routed through an HRSG of a combined cycle power plant (“CCPP”). However, it is contemplated that the exhaust gas attemperating device can be utilized for controlling a temperature of exhaust gases being routed through any suitable portion of an exhaust track of various power generation systems. Further, in these embodiments, the exhaust gas attemperating device is a component of a system for simultaneously purging an HRSG and firing a gas turbine combustor, based on a series of inputs including a temperature of the exhaust gases, a load demand, a speed of a compressor portion of the gas turbine and a combination thereof. However, it is contemplated that the exhaust gas attemperating device can be integrated within a variety of suitable open loop control systems, closed loop control systems and combinations thereof, utilizing various inputs.

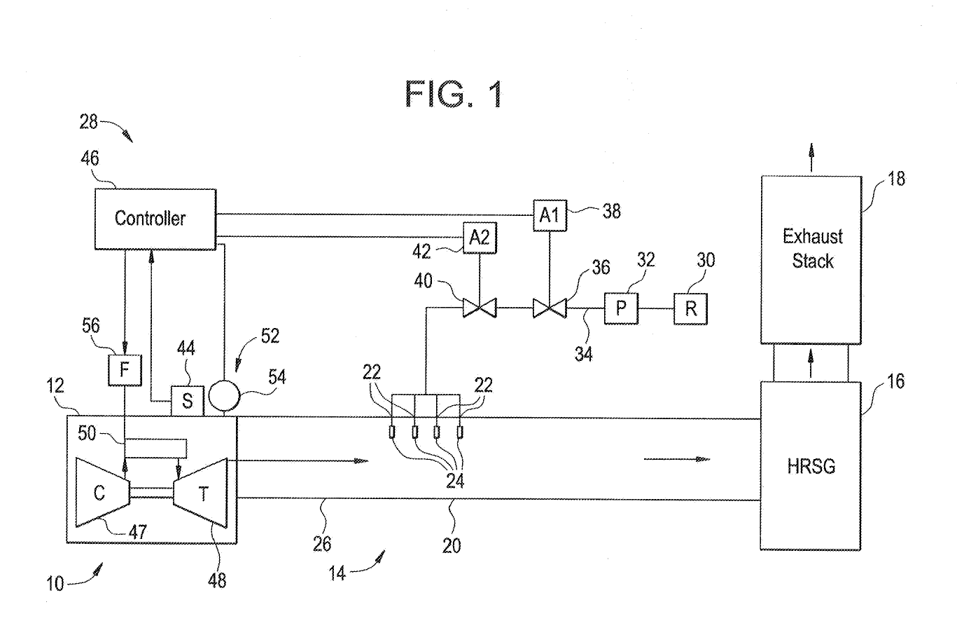

Referring to FIG. 1, a power generation system 10 in accordance with an exemplary embodiment is provided. The power generation system 10 is a CCPP having a gas turbine 12, an exhaust gas attemperating device 14, an HRSG 16 and an exhaust stack 18.

The gas turbine 12 is configured to combust a mixture of compressed air and fuel for generating electricity. A byproduct of the combustion of the compressed air and fuel are exhaust gases. The exhaust gases from the gas turbine 12 are routed through a conduit 20 to the HRSG 16.

The exhaust gas attemperating device 14 includes the conduit 20 in fluid communication with the gas turbine 12. The conduit 20 is configured to receive the exhaust gases from the gas turbine 12 and has at least one aperture 22 extending therethrough. The exhaust gas attemperating device 14 further includes at least one atomizing nozzle 24 extending through the apertures 22 of the conduit 20 and configured to inject a liquid through the apertures 22 into the conduit 20, such that the liquid evaporates and decreases a temperature and an oxygen concentration of the exhaust gases in the conduit 20. One non-limiting example of the liquid is water, particularly a condensate pump discharge of the CCPP. The apertures 22 and nozzles 24 therein are located at an end portion 26 of the conduit 20 adjacent to the gas turbine 12 and are sufficiently arranged on the conduit 20 for uniformly atomizing and injecting the liquid into the conduit 20, such that exhaust gases are evenly quenched to eliminate streaks of high temperature exhaust gases that are routed to the HRSG 16. It is contemplated that the apertures 22 and nozzles 24 can be integrated in other portions of the conduit 20 in a variety of suitable arrangements.

The HRSG 16 is in fluid communication with the conduit 20 of the exhaust gas attemperating device 14. The HRSG 16 is configured to receive the exhaust gases from the conduit 20 of the exhaust gas attemperating device 14. Further, the exhaust stack 18 is in fluid communication with the HRSG 16 and is configured to direct the exhaust gases from the HRSG 16 to the atmosphere.

The power generation system 10 further includes a system 28 for controlling a temperature of the exhaust gases of the gas turbine 12. The system 28 includes a reservoir 30, a pump 32, a fluid duct 34, an isolation valve 36, a first actuator 38, a control valve 40, a second actuator 42, a speed sensor 44, a controller 46 and the exhaust gas attemperating device 14.

The reservoir 30 contains the liquid and is in fluid communication with the fluid duct 34. Further, the fluid duct 34 is in fluid communication with the atomizing nozzles 24, such that the reservoir 30 is configured to deliver the liquid through the fluid duct 34 and the atomizing nozzles 24 into the conduit 20.

The pump 32 is coupled to the fluid duct 34 and is configured to pump the liquid therethrough. However, it is contemplated that the pump 32 can instead be omitted from the power generation system 10, for instance when the reservoir 30 is a water tower or other suitable fluid delivery mechanism.

The isolation valve 36 is coupled to the fluid duct 34 and configured to move between open and closed operational positions as an on/off valve. The liquid is routed from the reservoir 30 through the fluid duct 34 and the atomizing nozzles 24 into the conduit 20 when the isolation valve 36 is moved to the open operational position. The isolation valve 36 blocks the fluid duct 34 when the isolation valve 36 is moved to the closed operational position.

The first actuator 38 is coupled to the isolation valve 36 and is configured to move the isolation valve 36 between the open and closed operational positions in response to first and second actuation signals, respectively, received from the controller 46 as discussed in detail below.

The control valve 40 is coupled to a portion of the fluid duct 34 between the isolation valve 36 and the atomizing nozzles 24. The control valve 40 is configured to move among a plurality of intermediate operational positions, such that the liquid in the fluid duct 34 has at least a portion of a flow rate through the isolation valve 36 when the isolation valve 36 is moved to an open operational position.

The second actuator 42 is coupled to the control valve 40 and is configured to move the control valve 40 among the plurality of intermediate operational positions in response to a plurality of control valve actuation signals, respectively, received from the controller 46 as discussed in detail below.

The speed sensor 44 is operably coupled to a compressor portion 47 of the gas turbine 12. The speed sensor 44 is configured to generate a speed signal indicative of a speed of the compressor portion 47.

The controller 46 is configured to receive the speed signal from the speed sensor 44 and determine a speed value based on the speed signal. The controller 46 is further configured to generate the first actuation signal to induce the first actuator 38 to move the isolation valve 36 to the open operational position when the controller 46 determines that the speed value is equal to or greater than a threshold speed value. One non-limiting example of the threshold speed value is equal to a minimum speed for firing a combustor portion 50 of the gas turbine 12 corresponding to approximately 15% of the maximum compressor portion speed.

The system 28 further includes a starter generator system 52 having a starter motor 54 coupled to the gas turbine 12. The starter generator system 52 is configured to rotate the compressor portion 47 and start the gas turbine 12 in response to a start actuation signal generated by the controller 46. In particular, the starter motor 54 is configured to utilize electricity for increasing rotational speed of the compressor portion 47 of the gas turbine 12 to a threshold firing speed at which the combustor portion 50 can be ignited. Accordingly, the starter generator system 52 enables the gas turbine 12 to function as a fan for directing ambient air through the HRSG 16 and exhaust stack 18. The controller 46 is further configured to initiate a first countdown sequence after the controller 46 generates the first actuation signal. Accordingly, during the first countdown sequence, the gas turbine 12 directs a mixture of ambient air and the liquid through the HRSG 16 and exhaust stack 18. One non-limiting example of the first countdown sequence has a time duration in a range between thirty seconds and sixty seconds.

The system 28 further includes a fuel delivery mechanism 56 that is configured to deliver a predetermined fuel flow rate to the gas turbine 12 in response to a fuel actuation signal generated by the controller 46 when the controller 46 determines that the first countdown sequence has expired.

The controller 46 is further configured to initiate a second countdown sequence, after the controller 46 determines that the first countdown sequence has expired and after the controller 46 generated the fuel actuation signal. During the second countdown sequence, the controller 46 is further configured to generate a plurality of control valve actuation signals to induce the second actuator 42 to move the control valve 40 among a plurality of intermediate operational positions, such that the liquid flows through the atomizing nozzles 24 into the conduit 20 at a flow rate that is equal to at least a portion of a maximum flow rate through the isolation valve 36 in the fully open operational position. The controller 46 generates the plurality of control valve actuation signals based on the speed signal, a load demand signal or any combination thereof as discussed in detailed below. Accordingly, the gas turbine 12 is operating in a fired state and directing a flow of quenched exhaust gases through the HRSG 16 and exhaust stack 18 during the second countdown sequence. One non-limiting example of the second countdown sequence has a time duration of five minutes.

The controller 46 is further configured to generate the second actuation signal to induce the first actuator 38 to move the isolation valve to the closed operational position when the controller 46 determines that the second countdown sequence has expired. In one non-limiting embodiment, the system 28 is configured to provide a flow of exhaust gases through the HRSG 16 that is equal to a product of a volume of the HRSG 16 and a factor of at least five.

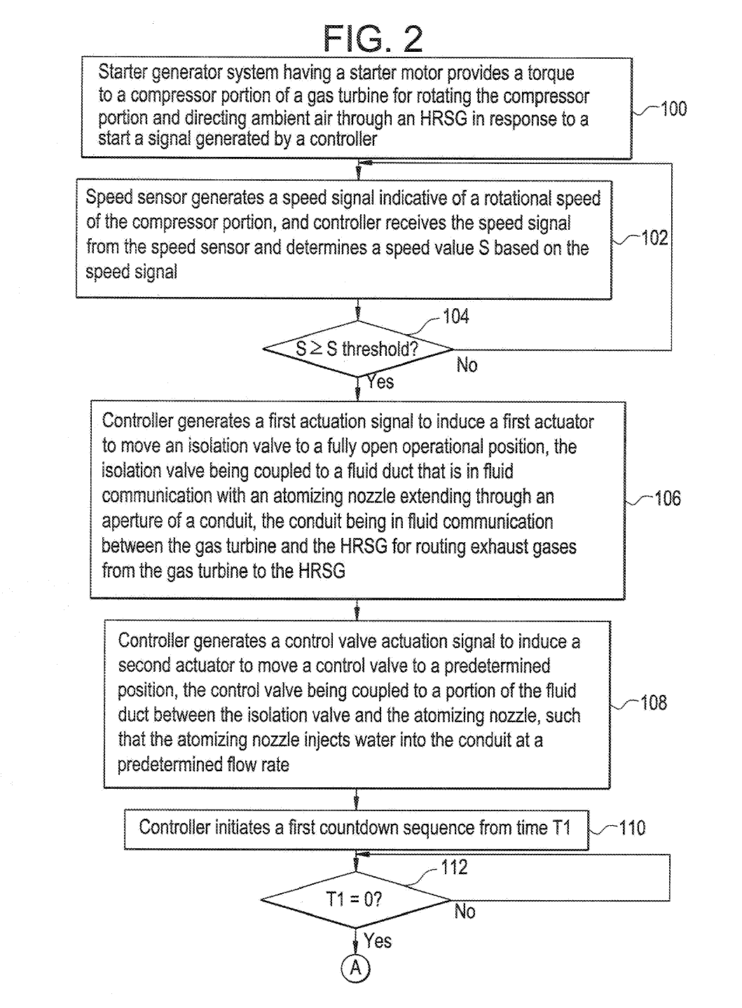

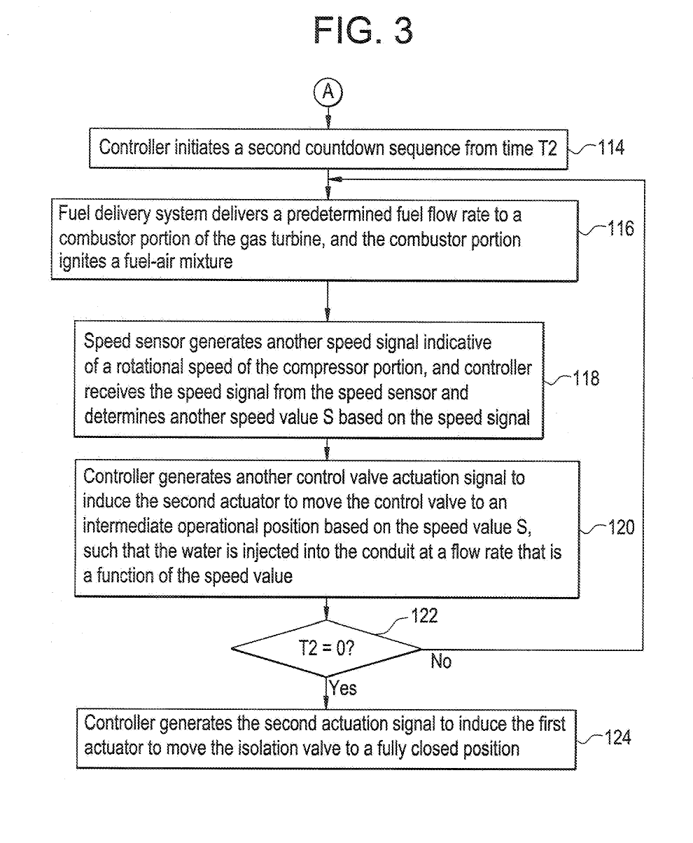

Referring to FIGS. 2 and 3, a flowchart of a method for controlling a temperature of exhaust gases utilizing the exhaust gas attemperating device of FIG. 1 based on a speed of the compressor portion 47 of the gas turbine 12, in accordance with an exemplary embodiment, will now be described.

At step 100, the starter motor 54 of the starter generator system 52 provides a torque to the compressor portion 47 of the gas turbine 12 for rotating the compressor portion 47 and directing ambient air through the HRSG 16.

Next at step 102, the speed sensor 44 generates a speed signal indicative of a rotational speed of the compressor portion 47. The controller 46 is configured to receive the speed signal from the speed sensor 44 and determine a speed value based on the speed signal.

Next at step 104, the controller 46 determines whether the speed value is greater than or equal to a threshold speed value. One non-limiting example of the threshold speed value is equal to a minimum speed for firing a combustor portion 50 of the gas turbine 12 corresponding to approximately 15% of the maximum compressor portion speed. If the value of step 104 equals “no”, then the method returns to step 102. However, if the value of step 104 equals “yes”, then the method proceeds to step 106.

At step 106, the controller 46 generates the first actuation signal to induce the first actuator 38 to move the isolation valve 36 to an open operational position.

Next at step 108, the controller 46 generates a control valve actuation signal to induce the second actuator 42 to move the control valve 40 to a predetermined intermediate operational position, such that the liquid is routed through the atomizing nozzles 24 into the conduit 20 at a predetermined flow rate. One non-limiting example of the predetermined intermediate operational position is a fully open position.

Next at step 110, the controller 46 initiates a first countdown sequence from time T1. One non-limiting example of T1 is within a range between about thirty and about sixty seconds.

Next at step 112, the controller 46 determines whether T1 equals zero. If the value of step 112 equals “no”, then the method repeats step 112. Accordingly, a mixture of ambient air and the liquid continues to be routed into the conduit 20 at the predetermined flow rate and through the HRSG 16 during the first countdown sequence from T1.

However, if the value of step 112 equals “yes”, then the method proceeds to step 114.

At step 114, the controller 46 initiates a second countdown sequence from time T2. One non-limiting example of T2 is equal to about five minutes, which can enable an air mass flow through the HRSG 16 equal to a product of a volume of the HRSG 16 and a factor of at least five.

Next at step 116, the fuel delivery mechanism 56 delivers a predetermined fuel flow rate to the combustor portion 50 of the gas turbine 12, and the combustor portion 50 ignites the fuel-air mixture.

Next at step 118, the speed sensor 44 generates another speed signal indicative of a rotational speed of the compressor portion 47, and the controller 46 determines a speed value based on the speed signal received from the speed sensor 44.

Next at step 120, the controller 46 generates another control valve actuation signal to induce the second actuator 42 to move the control valve 40 to another intermediate operational position based on the speed value. Accordingly, the liquid is routed through the atomizing nozzles 24 into the conduit 20 at a flow rate that is a function of the speed value and equal to at least a portion of the maximum flow rate through the isolation valve 36 when the isolation valve 36 is in the fully open operational position.

Next at step 122, the controller 46 determines whether T2 is equal to zero. If the value of step 122 equals “no”, then the method returns to step 116 and the system continues to quench the exhaust gases based on the speed value. However, if the value of step 122 equals “yes”, then the method proceeds to step 124.

At step 124, the controller 46 generates the second actuation signal to induce the first actuator 38 to move the isolation valve 36 to the closed operational position.

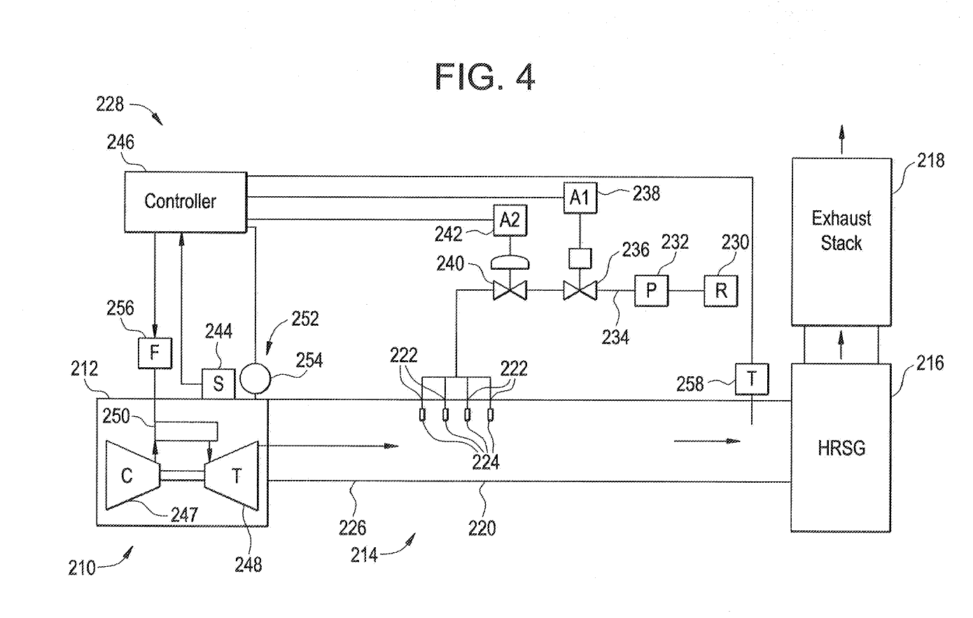

Referring to FIG. 4, a power generation system 210 in accordance with another exemplary embodiment is provided. The power generation system 210 has an exhaust gas attemperating device 214 and a system 228 for controlling a temperature of exhaust gases that is substantially similar to the power generation system 10 of FIG. 1 respectively having the exhaust gas attemperating device 14 and the system 28 for controlling a temperature of exhaust gases. However, the system 228 further includes a temperature sensor 258 disposed in the conduit 220 for generating a temperature signal indicative of a temperature of the exhaust gases routed from the exhaust gas attemperating device 214 toward the HRSG 216. In addition, during a second countdown sequence, the controller 246 is configured to generate a plurality of control valve actuation signals based on the temperature signal. In particular, the controller 246 is configured to further open the control valve 240 when the controller 246 determines that the temperature of the exhaust gases is greater than a threshold temperature value based on the temperature signal. One non-limiting example of the threshold temperature value is less than or equal to a difference between (i) an auto-ignition temperature of the fuel-air mixture delivered to the gas turbine 12 and (ii) 56 degrees Celsius.

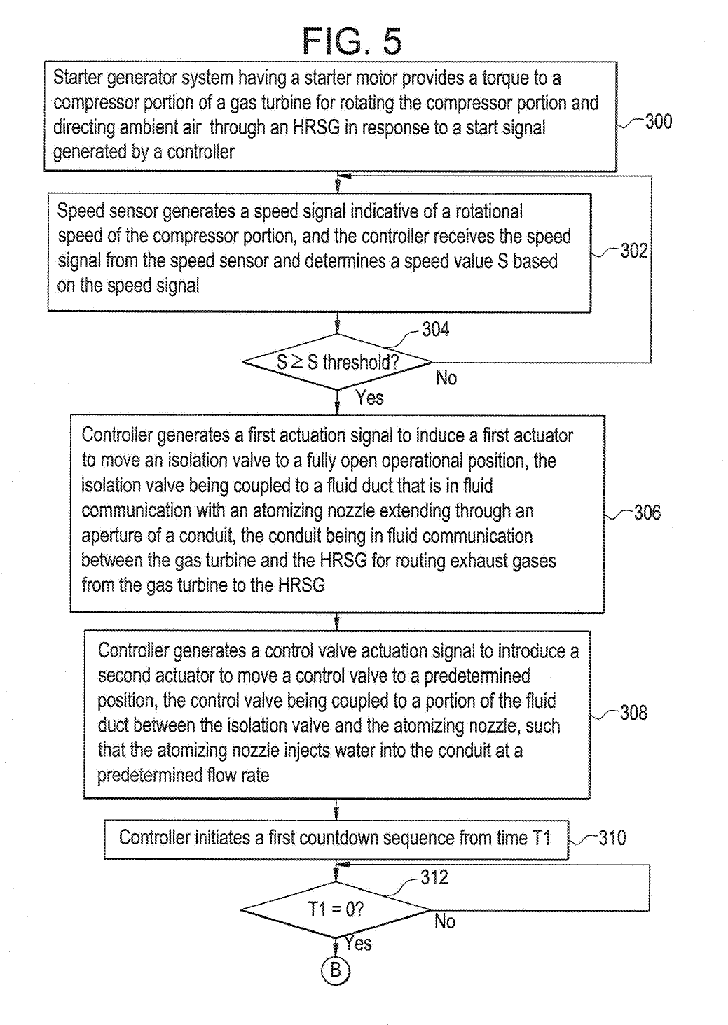

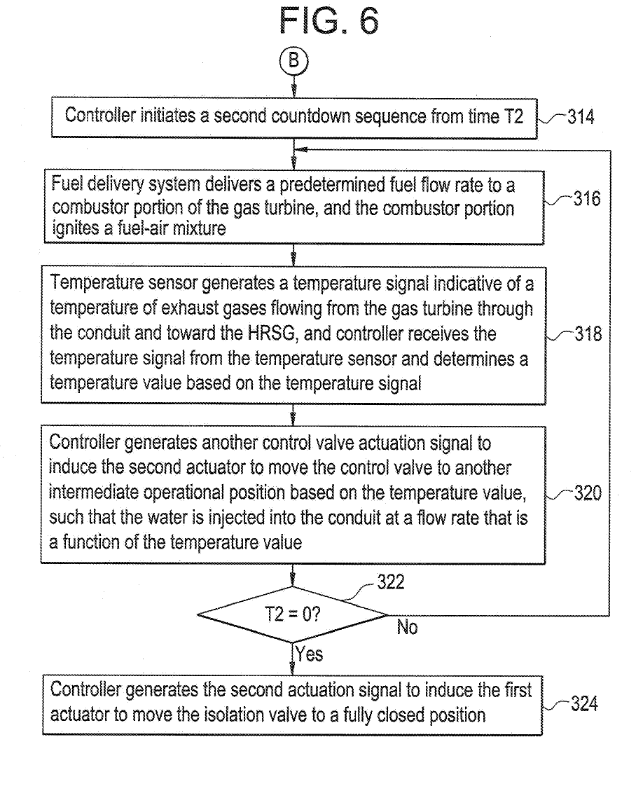

Referring to FIGS. 5 and 6, a flowchart of a method for controlling a temperature of exhaust gases utilizing the exhaust gas attemperating device 214 of FIG. 4 based on both a speed of the compressor portion 247 of the gas turbine 212 and a temperature of the exhaust gases, in accordance with another exemplary embodiment, will now be described.

At step 300, a starter motor 254 of the starter generator system 252 provides a torque to a compressor portion 247 of a gas turbine 212 for rotating a compressor portion 247 and directing ambient air through an HRSG 216.

Next at step 302, a speed sensor 244 generates a speed signal indicative of a rotational speed of a compressor portion 247. The controller 246 is configured to receive the speed signal from a speed sensor 244 and determine a speed value based on the speed signal.

Next at step 304, a controller 246 determines whether the speed value is greater than or equal to a threshold speed value. One non-limiting example of the threshold speed value is equal to a minimum speed for firing a combustor portion 50 of the gas turbine 12 corresponding to approximately 15% of the maximum compressor portion speed. If the value of step 304 equals “no”, then the method returns to step 302. However, if the value of step 304 equals “yes”, then the method proceeds to step 306.

At step 306, the controller 246 generates the first actuation signal to induce a first actuator 238 to move an isolation valve 236 to a fully open operational position.

Next at step 308, the controller 246 generates a control valve actuation signal to induce a second actuator 242 to move a control valve 240 to a predetermined intermediate operational position, such that the liquid flows through atomizing nozzles 224 into a conduit 220 at a predetermined flow rate. One non-limiting example of the predetermined intermediate operational position is a fully open position.

Next at step 310, the controller 246 initiates a first countdown sequence from time T1. One non-limiting example of T1 is within a range between about thirty and about sixty seconds.

Next at step 312, the controller 246 determines whether T1 equals zero. If the value of step 312 equals “no”, then the method repeats step 312. Accordingly, a mixture of ambient air and the liquid continues to be routed into the conduit 20 at the predetermined flow rate and through the HRSG 216 during the first countdown sequence from T1.

However, if the value of step 312 equals “yes”, then the method proceeds to step 314.

At step 314, the controller 246 initiates a second countdown sequence from time T2. One non-limiting example of T2 is equal to about five minutes, which can enable an air mass flow through the HRSG 216 equal to a product of a volume of the HRSG 216 and a factor of at least five.

Next at step 316, a fuel delivery mechanism 256 delivers a predetermined fuel flow rate to a combustor portion 250 of the gas turbine 212, and the combustor portion 250 ignites a fuel-air mixture.

Next at step 318, the temperature sensor 258 generates a temperature signal indicative of a temperature of the exhaust gases in the conduit 220, and the controller 246 determines a temperature value based on the temperature signal received from the temperature sensor 258.

Next at step 320, the controller 246 generates another control valve actuation signal to induce the second actuator 242 to move a control valve 240 to another intermediate operational position based on the temperature value. Accordingly, the liquid is routed through the atomizing nozzles 224 into the conduit 20 at a flow rate that is a function of the temperature value and equal to at least a portion of the predetermined flow rate through the isolation valve 236 when the isolation valve 236 is in the open operational position.

Next at step 322, the controller 46 determines whether T2 is equal to zero. If the value of step 322 equals “no”, then the method returns to step 316. However, if the value of step 322 equals “yes”, then the method proceeds to step 324.

At step 324, the controller 246 generates the second actuation signal to induce the first actuator 238 to move the isolation valve 236 to the closed operational position.

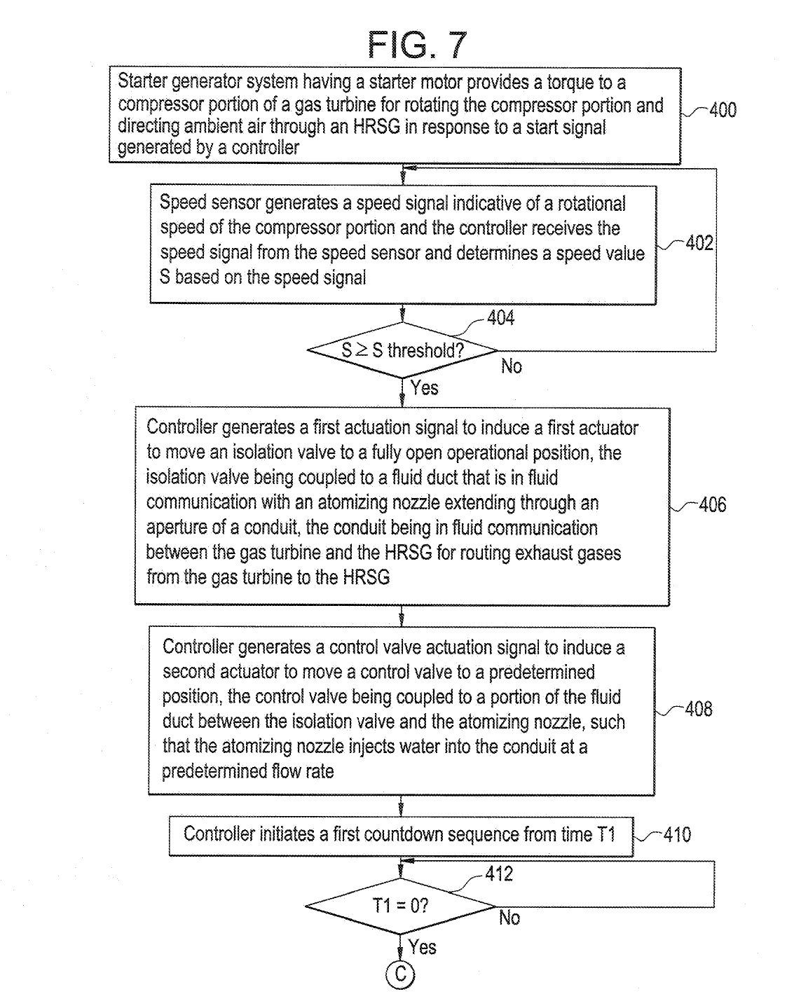

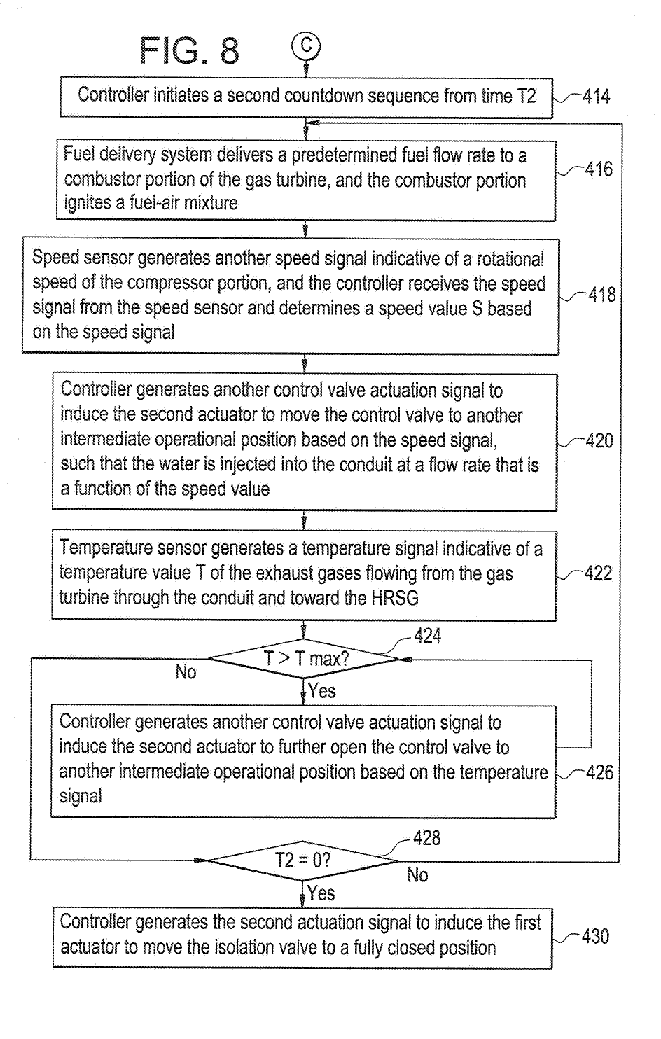

Referring to FIGS. 7 and 8, a flowchart of a method for controlling a temperature of exhaust gases utilizing the exhaust gas attemperating device of FIG. 4 based on both a rotational speed of the compressor portion 247 of the gas turbine 212 and a temperature of the exhaust gases, in accordance with another exemplary embodiment, will be described.

At step 400, the starter motor 254 of the starter generator system 252 provides a torque to the compressor portion 247 of the gas turbine 212 for rotating the compressor portion 247 and directing ambient air through the HRSG 216.

Next at step 402, the speed sensor 244 generates a speed signal indicative of a rotational speed of the compressor portion 247. The controller 246 is configured to receive the speed signal from the speed sensor 244 and determine a speed value based on the speed signal.

Next at step 404, the controller 246 determines whether the speed value is greater than or equal to a threshold speed value. One non-limiting example of the threshold speed value is equal to a minimum speed for firing a combustor portion 50 of the gas turbine 12 corresponding to approximately 15% of the maximum compressor portion speed. If the value of step 104 equals “no”, then the method returns to step 402. However, if the value of step 104 equals “yes”, then the method proceeds to step 406.

At step 406, the controller 246 generates the first actuation signal to induce the first actuator 238 to move the isolation valve 236 to a fully open operational position.

Next at step 408, the controller 246 generates a control valve actuation signal to induce the second actuator 242 to move the control valve 240 to a predetermined intermediate operational position, such that the liquid is routed through the atomizing nozzles 224 into the conduit 220 at a predetermined flow rate. One non-limiting example of the predetermined intermediate operational position is a fully open position.

Next at step 410, the controller initiates a first countdown sequence from time T1. One non-limiting example of T1 is in a range between about thirty and about sixty seconds.

Next at step 412, the controller determines whether T1 equals zero. If the value of step 412 equals “no”, then the method repeats step 412. Accordingly, a mixture of ambient air and the liquid continues to be routed into the conduit 220 at the predetermined flow rate and through the HRSG 216 during the first countdown sequence from T1.

However, if the value of step 412 equals “yes”, then the method proceeds to step 414.

At step 414, the controller initiates a second countdown sequence from time T2. One non-limiting example of T2 is equal to about five minutes, which can enable an air mass flow through the HRSG 216 equal to a product of a volume of the HRSG 216 and a factor of at least five.

Next at step 416, the fuel delivery mechanism 256 delivers a predetermined fuel flow rate to the combustor portion 250 of the gas turbine 212, and the combustor portion 250 ignites the fuel-air mixture.

Next at step 418, the speed sensor 244 generates another speed signal indicative of a rotational speed of the compressor portion 247, and the controller 246 determines a speed value based on the speed signal received from the speed sensor 244.

Next at step 420, the controller 246 generates another control valve actuation signal to induce the second actuator 242 to move the control valve 240 to another intermediate operational position based on the speed value. Accordingly, the liquid is routed through the atomizing nozzles 224 into the conduit 220 at a flow rate that is a function of the speed value and equal to at least a portion of the predetermined flow rate through the isolation valve 236 when the isolation valve 236 is in the open operational position.

Next at step 422, the temperature sensor 258 generates the temperature signal indicative of a temperature value T of the exhaust gases being routed from the gas turbine 212 through the conduit 220 and toward the HRSG 216.

Next at step 424, the controller 246 receives the temperature signal and determines whether the temperature value is greater than a threshold temperature value. One non-limiting example of the threshold temperature value is less than or equal to a difference between an auto-ignition temperature of the fuel-air mixture and about 56 degrees Celsius. If the value of step 424 is equal to “yes”, then the method proceeds to step 426.

At step 426, the controller 246 generates another control valve actuation signal to further open the control valve 240 to another intermediate operational position based on the temperature signal. Then, the method returns to step 424.

If the value of step 424 is equal to “no”, then the method proceeds to step 428.

At step 428, the controller 246 determines whether T2 is equal to zero. If the value of step 428 is equal to “no”, then the method returns to step 418. However, if the value of step 428 equals “yes”, then the method proceeds to step 430.

At step 430, the controller 246 generates the second actuation signal to induce the first actuator 238 to move the isolation valve to the closed operational position.

The power generation system, the exhaust gas attemperating device, and the system for controlling a temperature of exhaust gases represent a substantial advantage over other systems. In particular, the power generation system and the exhaust gas attemperating device provide a technical effect of injecting a liquid into exhaust gases from a gas turbine to decrease a temperature of the exhaust gases.

While the invention has been described with reference to an exemplary embodiment, various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. An exhaust gas attemperating device, comprising:
a conduit in fluid communication with a gas turbine, the conduit configured to receive exhaust gases from the gas turbine, the conduit having at least one aperture extending therethrough; and
at least one atomizing nozzle extending through the at least one aperture of the conduit and configured to inject a liquid through the at least one aperture into the conduit, such that the liquid evaporates and decreases a temperature and an oxygen concentration of the exhaust gases in the conduit.

2. The exhaust gas attemperating device of claim 1 further comprising a fluid duct and an isolation valve, the fluid duct being in fluid communication with the at least one atomizing nozzle for delivering the liquid to the at least one atomizing nozzle, the isolation valve configured to move between open and closed operational positions, the liquid flowing through the fluid duct and the at least one atomizing nozzle into conduit when the isolation valve is moved to the open operational position, the isolation valve blocking the fluid duct when the isolation valve is moved to the closed operational position.

3. The exhaust gas attemperating device of claim 2 further comprising an actuator coupled to the isolation valve, the actuator configured to move the isolation valve between the open and closed operational positions.

4. The exhaust gas attemperating device of claim 2 further comprising a control valve coupled to a portion of the fluid duct between the isolation valve and the at least one atomizing nozzle, the control valve configured to move among a plurality of intermediate operational positions, such that the liquid in the fluid duct has at least a portion of a flow rate through the isolation valve when the isolation valve is moved to the open operational position.

5. The exhaust gas attemperating device of claim 4 further comprising an actuator coupled to the control valve, the actuator configured to move the control valve among the plurality of intermediate operational positions.

6. The exhaust gas attemperating device of claim 2 further comprising a pump device coupled to the fluid duct, the pump device configured to pump the liquid through the fluid duct toward the at least one atomizing nozzle and into the conduit.

7. The exhaust gas attemperating device of claim 2 further comprising a reservoir containing the liquid and being in fluid communication with the fluid duct, the reservoir configured to deliver the liquid through the fluid duct and the at least one atomizing nozzle into the conduit.

8. A system for controlling a temperature and an oxygen concentration of exhaust gases produced by a gas turbine, comprising:
a fluid duct configured to route a liquid therethrough;
an isolation valve coupled to the fluid duct, the isolation valve configured to move between open and closed operational positions, the liquid being routed through the fluid duct when the isolation valve is moved to the open operational position, the isolation valve blocking the fluid duct when the isolation valve is moved to the closed operational position;
an actuator coupled to the isolation valve, the actuator configured to move the isolation valve between the open and closed operational positions in response to first and second actuation signals, respectively;
an exhaust gas attemperating device including at least one atomizing nozzle and a conduit, the conduit being in fluid communication with the gas turbine, the conduit configured to receive the exhaust gases from the gas turbine, the conduit having at least one aperture extending therethrough, the at least one atomizing nozzle extending through the at least one aperture of the conduit and being configured to inject the liquid through the at least one aperture into the conduit, such that the liquid evaporates in the conduit and decreases a temperature and an oxygen concentration of the exhaust gases in the conduit;
a speed sensor coupled to a compressor portion of the gas turbine, the speed sensor configured to generate a speed signal indicative of a speed of the gas turbine; and
a controller configured to receive the speed signal from the speed sensor and to determine a speed value based on the speed signal, the controller being further configured to generate the first actuation signal to induce the actuator to move the isolation valve to the open operational position when the controller determines that the speed value is greater than or equal to a threshold speed value.

9. The system of claim 8, further comprising a starter generator system coupled to the gas turbine and configured to operate the gas turbine, the controller further configured to initiate a first countdown sequence after the controller generates the first actuation signal, and the controller further configured to generate a start signal to induce the starter generator system to operate the gas turbine during the first countdown sequence.

10. The system of claim 9, further comprising a fuel delivery system coupled to the gas turbine for delivering fuel to the gas turbine, the controller being further configured to initiate a second countdown sequence after the first countdown sequence expires and to generate a fuel actuation signal to induce the fuel delivery system to deliver fuel to the gas turbine for ignition therein during the second countdown sequence.

11. The system of claim 10, wherein the controller is further configured to generate a second actuation signal after the second countdown sequence expires, to induce the actuator to move the isolation valve to the closed operational position.

12. The system of claim 8 further comprising a control valve coupled to a portion of the fluid duct between the isolation valve and the at least one atomizing nozzle, the control valve configured to move among a plurality of intermediate operational positions, such that the liquid in the fluid duct has at least a portion of a flow rate through the isolation valve when the isolation valve is moved to the open operational position.

13. The system of claim 12 further comprising another actuator coupled to the control valve, the another actuator configured to move the control valve among the plurality of intermediate operational positions in response to a plurality of control valve actuation signals generated by the controller.

14. The system of claim 13 wherein the controller is further configured to generate the plurality of control valve actuation signals based on the speed value, such that the liquid is injected into the conduit at a flow rate that is a function of the speed value.

15. The system of claim 13 further comprising a temperature sensor coupled to a portion of the conduit downstream of the at least one atomizing nozzle, the temperature sensor configured to generate a temperature signal indicative of a temperature of the exhaust gases, the controller being further configured to receive the temperature signal and generate the plurality of control valve actuation signals based on the temperature value of the exhaust gases.

16. A power generation system, comprising:
a gas turbine configured to produce exhaust gases; an exhaust gas attemperating device including a conduit and at least one atomizing nozzle, the conduit being in fluid communication with the gas turbine, the conduit configured to receive the exhaust gases from the gas turbine, the conduit having at least one aperture extending therethrough, the at least one atomizing nozzle extending through the at least one aperture of the conduit and configured to inject a liquid through the at least one aperture into the conduit, such that the liquid evaporates and decreases a temperature and an oxygen concentration of the exhaust gases in the conduit;
a heat recovery steam generator in fluid communication with the conduit of the exhaust gas attemperating device, the heat recovery steam generator configured to receive the exhaust gases from the conduit of the exhaust gas attemperating device; and an exhaust stack in fluid communication with the heat recovery steam generator, the exhaust stack configured to direct the exhaust gases from the heat recovery steam generator to the atmosphere.

17. The power generation system of claim 16 further comprising a reservoir and a fluid duct, the reservoir containing the liquid, the fluid duct being in fluid communication with the reservoir and configured to receive the liquid from the reservoir, the at least one atomizing nozzle being in fluid communication with the fluid duct and configured to receive the liquid from the fluid duct.

18. The power generation system of claim 17 further comprising an isolation valve coupled to the fluid duct, the isolation valve configured to move between open and closed operational positions, the liquid being routed through the fluid duct and the at least one atomizing nozzle into conduit when the isolation valve is moved to the open operational position, the isolation valve blocking the fluid duct when the isolation valve is moved to the closed operational position.

19. The power generation system of claim 18 further comprising an actuator coupled to the isolation valve, the actuator configured to move the isolation valve between the open and closed operational positions.

20. The power generation system of claim 17 further comprising a control valve coupled to a portion of the fluid duct between the isolation valve and the at least one atomizing nozzle, the control valve configured to move among a plurality of intermediate operational positions, such that the liquid in the fluid duct has at least a portion of a flow rate through the fluid duct when the isolation valve is moved to the open operational position.

21. An exhaust gas attemperating device, comprising:
a conduit configured to receive exhaust gases, the conduit having at least one aperture extending therethrough; and
at least one atomizing nozzle extending through the at least one aperture of the conduit and configured to inject water through the at least one aperture into the conduit, such that the water evaporates and decreases a temperature and an oxygen concentration of the exhaust gases in the conduit.

22. A system for controlling a temperature and an oxygen concentration of exhaust gases, comprising:
a fluid duct configured to route water therethrough;
an isolation valve coupled to the fluid duct, the isolation valve configured to move between open and closed operational positions, the water being routed through the fluid duct when the isolation valve is moved to the open operational position, the isolation valve blocking the fluid duct when the isolation valve is moved to the closed operational position;
an actuator coupled to the isolation valve, the actuator configured to move the isolation valve between the open and closed operational positions in response to first and second actuation signals, respectively;
an exhaust gas attemperating device including at least one atomizing nozzle and a conduit, the conduit configured to receive the exhaust gases, the conduit having at least one aperture extending therethrough, the at least one atomizing nozzle extending through the at least one aperture of the conduit and being configured to inject the water through the at least one aperture into the conduit, such that the water evaporates in the conduit and decreases a temperature and an oxygen concentration of the exhaust gases in the conduit; and a controller configured to generate the first and second actuation signals to induce the actuator to move the isolation valve between the open and closed operational positions, respectively.
